(19) United States
(12) Patent Application Publication
(10) Pub. No.: US 2026/0339567 A1
(43) Pub. Date: Oct. 29, 2026

(54) CLASSIFYING A WORKLOAD OF WARP SPECIFIC I/O COMMANDS

(71) Applicant: Micron Technology, Inc., Boise, ID (US)

(72) Inventor: Chandra Guda, Fremont, CA (US)

(21) Appl. No.: 19/654,731

(22) Filed: Apr. 22, 2026

Related U.S. Application Data
(60) Provisional application No. 63/795,033, filed on Apr. 25, 2025.

(51) Int. Cl. G06F 3/06

(52) U.S. Cl. CPC G06F 3/0659; G06F 3/061; G06F 3/0679

(57) ABSTRACT

A processing device in a memory sub-system configured to receive, from a host system, a sequence of input/output (I/O) commands associated with a warp of the host system, wherein the warp comprises a set of processing threads of the host system that synchronously execute a same sequence of executable instructions; receive a context attribute associated with the warp; execute the sequence of I/O commands by performing, based on the context attribute, a plurality of memory access operations with respect to the memory device.

### RELATED APPLICATIONS

This application claims the benefit of U.S. Provisional Application No. 63/795,033, filed Apr. 25, 2025, the entire contents of which is hereby incorporated by reference herein.

### TECHNICAL FIELD

Embodiments of the disclosure relate generally to memory sub-systems, and more specifically, relate to classifying a workload of warp specific I/O commands.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating the warp queue pairs in the host memory of a host system, in accordance with some embodiments of the present disclosure.

FIG. 3 is a block diagram showing a submission queue and a completion queue in detail, in accordance with some embodiments of the present disclosure.

FIG. 4 schematically illustrates example queue metadata generated by a host system, in accordance with aspects of the present disclosure.

FIG. 5 is a block diagram illustrating an arbitration schedule between legacy queue pairs and warp queue pairs, in accordance with aspects of the present disclosure.

FIG. 6 is a flow diagram of an example method of processing warp specific I/O commands, in accordance with some embodiments of the present disclosure.

FIG. 7 is a block diagram of an example computer system in which embodiments of the present disclosure may operate.

### DETAILED DESCRIPTION

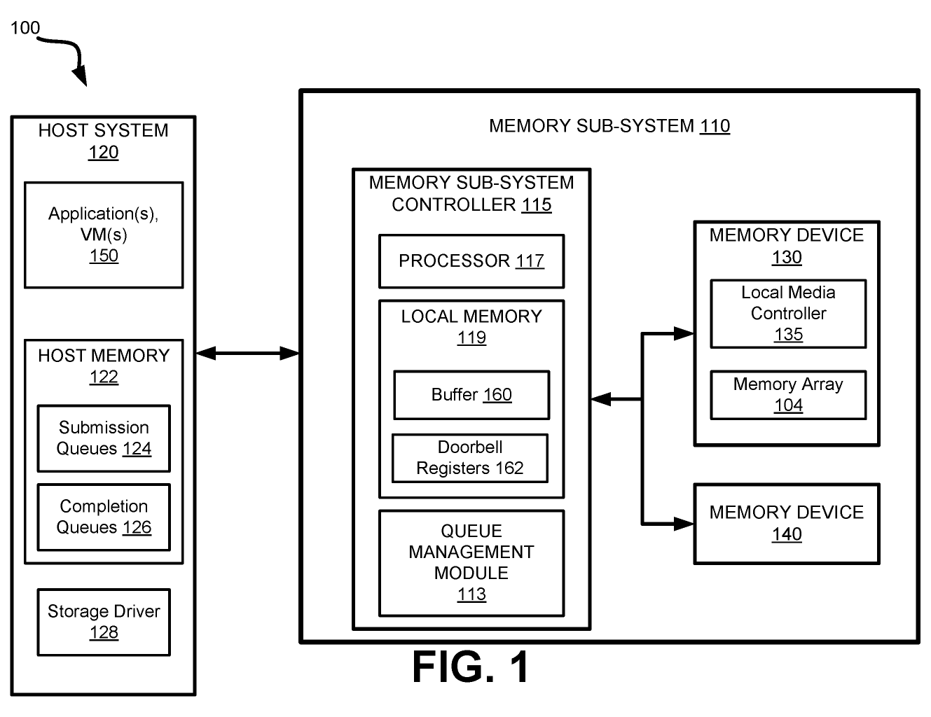

Aspects of the present disclosure are directed to assigning type classifiers to warp specific I/O commands. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a NAND memory device, such as 3D flash NAND memory, which offers storage in the form of compact, high-density configurations. Other examples of non-volatile memory devices are described below in conjunction with FIG. 1. A non-volatile memory device is a package of one or more dice, each including one or more planes. For some types of non-volatile memory devices (e.g., NAND memory devices), each plane includes a set of physical blocks. Each block include a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple cells arranged in a two-dimensional or a three-dimensional grid. Memory cells are typically joined by wordlines (conducting lines electrically connected to the cells’ control gates) and programmed together as memory pages (e.g., 16 KB or 32KB pages) in one setting (by selecting consecutive bitlines connected to the cells’ source and drain electrodes). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

One example of a memory sub-system is a solid-state drive (SSD) that includes one or more non-volatile memory devices and a memory sub-system controller to manage the non-volatile memory devices. Memory access commands, such as those sent by the host system, request the memory sub-system to perform memory access operations on the memory devices contained therein. Memory access commands can generally be classified into respective categories, such as read commands, write commands, erase commands, move commands, etc. A memory sub-system controller can receive the memory access commands from the host system connected externally to the memory sub-system, such as via a Non-Volatile Memory Express (NVMe) interface on a Peripheral Component Interconnect Express (PCIe) communication bus. The memory sub-system can execute the memory access commands to perform the memory access operations and can store the results of the memory access commands for retrieval by the host system after the memory sub-system reports completion of the execution of the memory access commands.

A host system can include one or more graphics processing units (GPUs). GPUs can implement an array of Streaming Multiprocessors (SMs) in a parallel architecture. Accordingly, the processing threads can be grouped into thread blocks that are distributed across the available SMs (e.g., each SM can be configured to execute one or more of the thread blocks). A thread block can be further divided into a set of warps, such that each warp includes a fixed number of processing threads (e.g., 32 processing threads per warp). In particular, a warp is a group of processing threads that are scheduled together to synchronously execute the same stream of executable instructions. Within each SM, threads of a warp are executed in a Single-Instruction, Multiple-Thread (SIMT) manner. Specifically, a warp scheduler within each SM can fetch a single instruction and broadcast that instruction to all active processing threads within the warp. Each processing thread can have its own set of registers and can execute the instruction on different data elements (e.g., perform read operations on different locations of a memory device). This allows certain SMs to be dedicated to performing specific workloads. For example, one SM can be dedicated to performing only read operations while another SM can be dedicated to performing only write operations. This parallel execution model can maximize throughput for data-parallel computations.

A host system can maintain a set of queues to track input/output (I/O) commands issued by the processing threads. An I/O command is an instruction sent by host system to a peripheral device, such as a memory sub-system. This command directs the memory sub-system to perform a specific action related to the transfer of data into the host system (input) or out of the host system (output), or to control the device's operational state. I/O commands can include memory access commands issued to the memory sub-system (e.g., read commands, write commands, erase commands, move commands, etc.), commands to perform arithmetic functions, to perform a restore operation, to perform a cache offload operation, etc. For example, the host system can maintain a set of submission queues, such that each submission queue entry can store a data structure representing respective I/O command issued to the memory sub-system. The host system can further maintain a set of completion queues, such that each completion queue entry can store information about the result of a completed command. The host system can maintain these queues in a volatile host memory, such as on a dynamic random-access memory (DRAM) device.

The submission and completion queues can be organized as circular buffers due to their efficiency in handling I/O command flow of the GPU. A circular submission queue allows the host system to post a sequence of I/O commands to the memory device without requiring the memory sub-system to process them immediately, while a corresponding circular completion queue enables the memory sub-system to report the status of completed commands back to the host system. The I/O commands are inserted at certain locations of each buffer as specified by a pointer. For example, a tail pointer indicates the position where new data is written, and is incremented with each new insertion, wrapping around to the beginning of the buffer once the end is reached. A head pointer is also used to track the location of the next entry to be processed, and advances as entries are retrieved and processed, similarly wrapping around when the end of the buffer is reached. The circular structure of these submission queues and completion queues allows them to efficiently reuse space while preventing overwriting of data, with the buffers being considered full when the next position of the tail pointer would coincide with the head pointer. A host system can configure multiple circular buffers for linear workloads. By using multiple command queues and completion queues, the host system can prepare I/O commands for the next set of tasks while the memory sub-system is still processing a current set, effectively overlapping host system preparation with memory sub-system execution.

In some systems, when an SM of a GPU requires data operations (e.g., write commands, read commands, etc.) to be performed on a memory device, each thread within a warp, at the instruction of the GPU, can generate a responsive set of I/O commands. All I/O commands generated by the threads of the warp can then be organized and placed, by the respective threads, into multiple submission queues to be processed asynchronously and without a context (e.g., the host system would not have any information identifying the warp to which the I/O commands). For example, one or more I/O commands can be placed into a first submission queue, another one or more I/O commands can be placed into a second queue, and so forth. For each submission queue, the host system can alert the memory sub-system that the I/O command(s) is ready for processing, by writing a value to a doorbell register assigned to that submission queue. A doorbell register is a special memory-mapped I/O (MMIO) register used as a notification mechanism between a host system and the memory sub-system controller. The write operation to the doorbell register triggers the memory sub-system to fetch I/O commands from the corresponding submission queue and process them.

Each submission queue can be paired with one or more completion queues. This pairing allows the host system to track the completion status of the I/O commands submitted through a specific submission queue. Once an I/O command is processed, the memory sub-system can write an entry into a corresponding completion queue. The completion queue entry serves as a notification to signal the successful or unsuccessful completion of the I/O command. For each entry, a write to a doorbell register corresponding to the completion queue is performed to inform the host system of the entry.

In current storage access protocols (memory access protocols between the host and the memory sub-system), such as the NVMe protocol, the memory sub-system is unable to classify the workload (pattern and intensity) of warp specific I/O commands. Rather, the memory sub-system obtains each I/O command from the submission queue and then determines the type of every I/O command received (e.g., a write command, a read command, etc.). As such, the memory sub-system expends significant computing resources to determine each received I/O command type. Current systems are able to provide, for processing, hundreds to thousands of warps per cycle, and each warp can correspond to 32 I/O commands. This causes the memory sub-system to consume considerable processing resources to determine the type of each received I/O command, which results in a significant increase in latency.

Aspects of the present disclosure address the above and other deficiencies by allowing the host system to group together I/O commands originated by a given warp and notify the memory sub-system of the workload type of a group of I/O commands originated by the warp. In particular, the memory sub-system controller can receive instructions from the host system to configure a warp-mode queue pair (e.g., a submission queue and a corresponding completion queue) in the host memory. The submission queue of the warp queue pair can reside in a memory buffer dedicated to storing the I/O commands originated by one or mor warps. The completion queue of the warp queue pair can reside in a memory buffer dedicated to storing the entries received from the memory sub-system to indicate that the corresponding I/O commands have been executed.

Thus, the host system can place the I/O commands for a particular warp into a corresponding submission queue. For example, I/O commands for warp A can be placed into submission queue A, I/O commands for warp B can be placed into submission queue B, and so forth. Once a threshold number of I/O commands are placed in a particular submission queue, the host system can write a value to a corresponding doorbell register to instruct the memory sub-system to process these I/O commands.

In some embodiments, the host system can create a warp context data structure (e.g., a metadata table) to each submission queue. The data structure can store, for example, an identifier of the warp to which the I/O commands below, the number of I/O commands in the submission queue, and a context attribute identifying the workload type associated with the I/O commands that are currently in the submission queue. The memory sub-system can access the metadata table via PCIe direct memory access (DMA). The workload type can be, for example, random read commands, random write commands, sequential read commands, sequential write commands, prefill commands, key/value (KV) cache offload commands, etc. When the memory sub-system processes the I/O commands in a submission queue (e.g., in response to detecting a value written to a doorbell register), the memory sub-system can use the context attribute to determine the workload type in the submission queue. The memory sub-system can then process the I/O commands according to their workload type.

Advantages of the present disclosure include, but are not limited to, configuring queue pairs to enable a memory sub-system to identify the type of the I/O commands placed in a warp submission queue. Since all the I/O commands would be of the same type, providing a queue-based label eliminates the memory sub-system from identifying operations for each received I/O command. This can result in an improvement in the performance and speed of the memory sub-system, a reduction of memory consumption, and a decrease in power consumption by the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In some embodiments, the host system 120 can run one or more applications (e.g., virtual machines) 150. The applications 150 can be executed by multiple processing cores (e.g., central processing units, graphics processing units) which can process many threads/streams in parallel. For example, host system 120 can include hundreds of parallel processing threads that can generate respective host-initiated I/O commands (e.g., read command, write commands, arithmetic commands, offload commands, prefill commands, etc.) directed to memory sub-system 110 concurrently. In some embodiments, the host system 120 utilizes a set of queues to track the I/O commands issued to the memory sub-system 110. For example, the host system 120 can include multiple submission queues 124, storing submission queue entries representing the I/O commands issued to the memory sub-system 110, and multiple completion queues 126, storing completion queue entries representing I/O command completion statuses received from the memory sub-system 110. In some embodiments, the host system 120 can maintain these queues in a host memory 122, such as a dynamic random access memory (DRAM) device or other memory device. A submission queue and its corresponding completion queue can be referred to as a “queue pair.” Submission queues 124 and completion queues 126 can include circular buffers, linear buffers, stream buffers, etc., each with a fixed slot size and/or a variable slot size. In some embodiments, there can be some other number of queues or queue pairs in host memory 122.

In some embodiments, memory sub-system controller 115 can provide host system 120 with the ability to group I/O commands, for a warp, together in the same submission queue. In particular, memory sub-system controller 115 can configure one or more warp queue pairs (in the host memory 122) such that the submission queue 124 of the warp queue pairs can store all of the I/O commands for one or more warps.

In some embodiments, host system 120 includes storage driver 128. Storage driver 128 can request for the memory sub-system to generate one or more queue pairs (e.g., one or more submission queue 124 and one or more corresponding completion queues 126). In some embodiments, storage driver 128 can request one or more queue pairs that support GPU based parallelization. To generate these queue pairs, referred to as a warp queue pairs, storage driver 128 can allocate memory, in the host memory 122, for the creation of the warp queue pairs. In some implementations, the allocated memory can be contiguous memory (e.g., a block of memory where data is stored in a sequential, uninterrupted manner). Storage driver 128 can then instruct the memory sub-system controller 115 to configure one or more sets of warp queue pairs (also referred to as “queue pairs”) in the allocated memory. In some embodiments, the instruction can include the physical addresses of the allocated memory, the requested queue size (e.g., number of entries per queue), related queue identifiers (QID), etc. In other embodiments, storage driver 128 can instruct the memory sub-system controller 115 to configure one or more sets of warp queue pairs in the host memory and then memory sub-system controller 115 can allocate the memory for the queue pair(s). In some embodiments, the host system 120 can also request one or more legacy queue pairs. The legacy queue pair can include a legacy submission queue and legacy completion queue. Each of the legacy queues can include, for example, a circular memory buffer where I/O commands are processed one at a time. When submitting a command processing request to the memory sub-system 110 (e.g., via a write operation to a doorbell register), the host system can indicate whether to process the I/O commands in the queue using legacy mode or warp mode.

In some embodiments, storage driver 128 can provide one or more queue setup parameters to memory sub-system 110 for the configuration of submission queues 124 and/or completion queues 126. A queue setup parameter can be a configurable value that defines the characteristics and behavior of a queue data structure (e.g., submission queue 124 and/or completion queues 126). The queue setup parameters can include, for example, a batch operating mode, a queue size, a warp offset value, a warp doorbell pointer, and/or a maximum warp support value. The warp operating mode can determine whether the queue pairs are configured to process warps in accordance with one or more of the embodiments of this disclosure or whether the queue pairs are configured to process individual I/O commands according to a legacy mode. This enable the host system to have backwards compatibility with systems that are not able to perform certain aspects of the batched operating mode. In some embodiments, storage driver 128 can instruct memory sub-system 110 to inform host system 120 whether memory sub-system 110 includes the hardware and/or software required to configure the warp queue pairs. The queue size can define the size of each queue (e.g., indicate the number of memory locations to allocate for the queue). The maximum warp support value can reflect the maximum number of warps that each queue can support.

The warp offset pointer represents an index or unique identifier assigned to each active or scheduled warp. In particular, the warp offset pointer can store the starting address of a section of the warp submission queue and/or of a warp completion queue, include a contiguous block of host memory 122 reserved for storing the I/O commands for a single warp. This pointer could be used by the host system 120 and/or memory sub-system 110 to track the state, priority, or assigned resources of each warp. For example, if the queue size is set to 96 memory locations (to accommodate the I/O commands for three warps of 32 processing threads per warp), then submission queue 124 and completion queue 126 can each include two warp offset pointers. Once configured, storage driver 128 can place the I/O commands for a particular warp into a particular section of the submission queue differentiated by the warp offset pointers.

In some embodiments, storage driver 128 can request hardware and/or software configuration data from memory sub-system 110. The configuration data can be used to determine the queue setup parameters. In some embodiments, storage driver 128 can request memory sub-system 110 to inform host system 120 of its capabilities related to one or more of the queue setup parameters. Once the queue setup parameters are determined using the configuration data or capabilities data, storage driver 128 can instruct memory sub-system 110 to configure the queue pair(s). In an illustrative example, the storage driver 128 can send the memory sub-system 110 a setup dataset such as the operating mode, the warp size (e.g., 32), the warp offset pointer list, and the maximum warp support value (e.g., 32). The operating mode can be indicated using operation codes (opcodes), such as, for example, opcode 00 can instruct the memory sub-system to operate in legacy mode while opcode 01 can instruct the memory sub-system to operation in batch mode. This allows the host system to modify how the queue pairs operate. The warp offset pointer list can be used by the memory sub-system to keep track of the allocated memory sections. In some embodiments, storage driver 128 can instruct memory sub-system 110 to determine one or more of the queue setup parameters based on the hardware and/or software capabilities of the memory sub-system 110 and/or the host system.

In some embodiments, memory sub-system 110 includes queue management module 113 which can configure the warp queue pairs and process the I/O commands for a warp. To configure the warp queue pairs, queue module 113 of memory sub-system 115 can obtain the physical addresses of the allocated memory in host memory and/or allocate a range(s) of physical address in host memory 122. This allows the memory sub-system controller 115 to directly access these host memory regions via, for example, a direct memory access (DMA) process. In some embodiments, the allocated memory can include reserved addresses for each queue pair. In other embodiments, queue module 113 can map memory for each queue pair from the memory allocated in host memory 122. When placing I/O commands into submission queue 124, storage driver 128 can assign a warp identifier to each submission queue and/or to a section of a submission queue. The warp identifiers can be used to track each I/O command for a corresponding warp.

In some embodiments, the memory sub-system controller 115 includes at least a portion of the queue management module 113. For example, the memory sub-system controller 115 can include a processor 117 (i.e., a processing device) configured to execute instructions stored in local memory 119 for performing the operations described herein. For example, buffer 160 can be implemented in local memory 119 or in some other memory of the memory sub-system controller 115 (e.g., a static random access memory (SRAM) device).

In some embodiments, queue management module 113 can periodically perform a scan of one or more doorbell registers 162 to determine whether a value has been written, by storage driver 128, to the register. A doorbell register can be a special memory-mapped I/O (MMIO) register used as a notification mechanism between host system 120 and memory sub-system controller 115. A write operation performed to a certain doorbell register 162 can instruct queue management model 113 to fetch one or more newly placed I/O commands from a corresponding submission queue 124 and to process the I/O commands. In some embodiments, once fetched, the I/O commands for the warp can be placed in buffer 160. Buffer 160 can be a memory sub-system buffer that temporarily holds the I/O commands retrieved from submission queue 124 before they are executed. Once the I/O commands are processed (e.g., data referenced by the I/O commands is retrieved from memory device 130), queue management module 113 can place a completion queue entry into the corresponding completion queue 126. Once the completion queue is updated, queue management module 113 can trigger an interrupt to notify the host system 120 that new completions are available. The host system 120 can read the completion queue entries, process the completions, and updates a completion queue doorbell register to inform the memory sub-system which completions have been consumed.

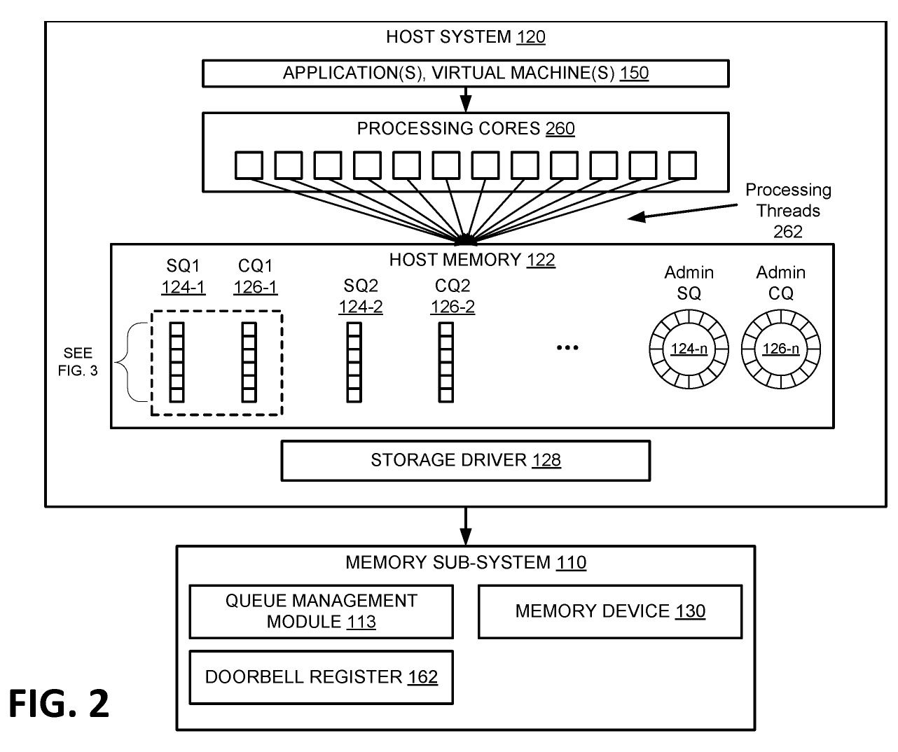

FIG. 2 is a block diagram illustrating the warp queue pairs in the host memory of a host system, in accordance with some embodiments of the present disclosure. As illustrated, host system 120 can run multiple applications 150, which can be executed by a number of processing cores 260. Host system 120 further includes host memory 122, which can store submission queues 124 and completion queues 126. For example, the queues in host memory 122 can be arranged into respective queue pairs, each queue pair including a submission queue (e.g., 124-1, 124-2, 124-n) and a corresponding completion queue (e.g., 126-1, 126-2, 126-n).

The applications and/or virtual machines 150 can perform operations that utilize memory sub-system 110. For example, the applications and/or virtual machines 150 can issue requests to read data which can be stored on memory device 130 of memory sub-system 110 or write data to the memory device 130. In some embodiments, these memory access requests are sent by the parallel processing threads 262 being executed by processing cores 260. Processing cores 260 can include various general-purpose processing devices such as microprocessors, central processing units (CPUs), or the like, or specialized processing devices, such as graphics processing units (GPUs), which may be optimized for performing high-speed sequential processing operations. Depending on the implementation there can be any number of processing cores 260 (e.g., tens or hundreds), each executing a respective one of processing threads 262. Each processing thread 262 represents a series of sequential operations directed to memory sub-system 110. Upon requests from each processing thread 262 being generated, the requests (e.g., I/O commands) can be stored as entries in one of submission queues 124-1, 124-2, 124-n, from which they can be issued to memory sub-system 110. Received responses to the requests from memory sub-system 110 can be stored as entries in one of completion queues 126-1, 126-2, 126-n, and then retrieved by processing threads 262 and provided to applications and/or virtual machines 150. While there can be any number of warp queue pairs dedicated for use with host-initiated I/O commands, host memory 122 can further include one or more queue pairs dedicated to administrative commands (e.g., administrative submission queue 124-n and administrative completion queue 126-n). While shown as circular buffers, the administrative queues can use any type of buffer.

In some embodiments, the submission queues 124-1, 124-2 and completion queues 126-1, 126-2 can be implemented as linear buffers, where I/O commands are inserted into certain sections of the buffer identified by a warp offset pointer. In particular, the warp offset pointer can indicate the beginning of a memory location reserved for storing the I/O commands for a single warp.

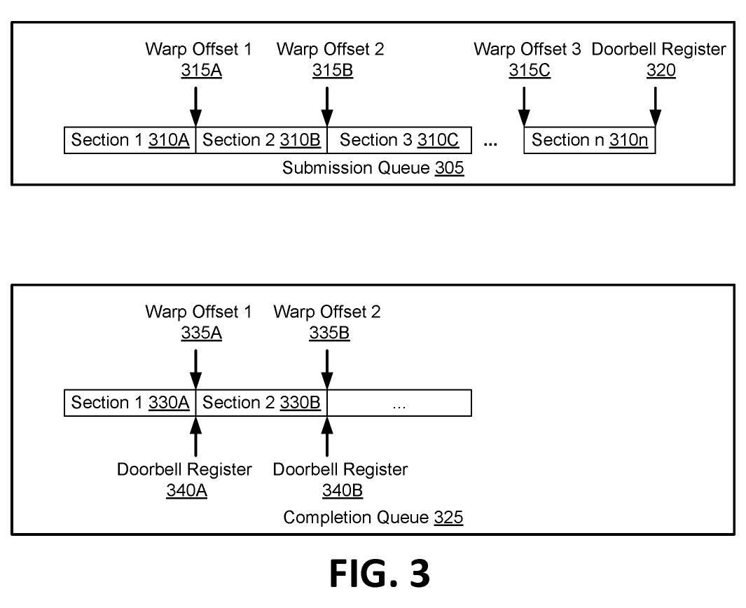

FIG. 3 is a block diagram showing submission queue 305 and completion queue 325 in detail. As shown, submission queue 305 is split into multiple sections (310A, 310B, 310C, 310n). Each section can be utilized to store the I/O commands of a single warp. Each section can be differentiated by a warp offset pointer. As shown, warp offset 1 315A indicates the differentiation of section 1 310A and section 2 310B. Warp offset 2 315B indicates the differentiation of section 2 310B and section 3 310C. Warp offset 3 315C indicates the differentiation of section 3 310C and section n 310n. One or more entry pointers can be used to track the location of the next data item to be processed in each section, can advance as entries are retrieved, and reset to an initial location once the entries are submitted for execution. For example, a head pointer can be used to track the position of the next empty location in a respective section while a tail pointer can be used to indicate the last position of the final possible location of a section.

Doorbell register 320 can be used to instruct the memory sub-system to process the I/O commands stored in the queue. For example, upon placing an entry to the warp submission queue, the host system can perform a write operation to the doorbell register to trigger the memory sub-system to perform a corresponding action (e.g., pull all of the I/O commands from submission queue 305 into an internal buffer for processing). In some embodiments, the doorbell register can be written to in response to each section of submission queue 305 being full of I/O commands. In other embodiments, the host system can perform a write operation to the doorbell register when fewer than the maximum number of entries are placed in the submission queue (e.g., a section can store 32 entries, and the host writes to the doorbell register once three entries are placed in the section). In other embodiments, multiple doorbell registers can be assigned to a single submission queue (e.g., a doorbell register for each section, a doorbell register for a set of sections, etc.).

Completion queue 325 can be arranged into multiple sections (330A, 330B). The entries can reference whether a corresponding I/O command has been successfully or unsuccessfully executed. In some embodiments, a section can be reserved for a particular warp. In other embodiments, each section can be free for the I/O commands of any warp (e.g., first come, first serve basis). The separation of two sections can be indicated using a warp offset pointer. As shown, warp offset 1 335A indicates the separation of section 1 330A and section 2 330B. Warp offset 2 335B indicates the separation of section 2 330B and another unlabeled section. An entry pointer can be used to track the location of the next data item to be processed in each section, can advance as entries are retrieved, and reset to an initial location once the entries are submitted to the host system.

Doorbell register 340 can be used to inform the host system that completion queue entries are stored in completion queue 325. For example, a write operation performed in the doorbell register to inform the host system of the entries. In some embodiments, the doorbell register can be written to in response to a particular section of completion queue 325 being full of entries. In other embodiments, the doorbell register can be written to in response to a corresponding section satisfying a threshold criterion (e.g., the section has a minimum number of entries). In other embodiments, a single doorbell register can be assigned to completion queue 325.

Returning to FIG. 2, in some embodiments, memory sub-system 110 can use a defined arbitration scheme to select submission queue entries from the various submission queues 124-1, 124-2, 124-n. The arbitration scheme can be defined by the memory sub-system (e.g., defined by the hardware architecture of the memory sub-system controller), the host system (e.g., defined by a request for a certain set of arbitration rules), or any combination thereof. In an example, when a threshold number of the entries (e.g., information representing I/O commands) related to a warp are added to a submission queue, the host system 120 can write to a corresponding doorbell register 162 in the memory sub-system to indicate the addition of the new entries. Processing logic (e.g., queue management module 113) in the memory sub-system can monitor these doorbell registers 162 to detect new entries and fetch the entries via PCIe direct memory access (DMA). If multiple warp submission queues are filled (or have sections filled) with pending entries for processing, the processing logic can utilize an arbitration scheme, such as round-robin, weighted round-robin, first-come, first-served (FCFS), priority-based selection, etc. Conventionally, the round-robin scheme would result in the processing logic retrieving a batch of entries from submission queue 124-1, then a batch of entries from submission queue 124-2, and so on, which may be referred to as the natural order. In some embodiments, queues or queue sections storing certain types of entries can have priority. For example, queues or sections storing read commands can be prioritized over queues or sections storing write commands. In some embodiments, one or more queues can be associated with weight. Accordingly, in instances when multiple submission queues are ready for processing, priority can be given to the queue with the highest corresponding weight value, then the queue with the next highest weight value, and so forth.

Once the I/O commands are processed, corresponding entries can be placed into a corresponding completion queue. Warp identifiers can be used to track each I/O command related to a corresponding warp. This allows queue management module 113 to place all of the I/O commands for a warp together in the same completion queue. This also allows queue management module 113 to write to a corresponding doorbell register to inform the host system that entries for each I/O command for a warp have all been added in the completion queue.

In some embodiments, storage driver 128 can classify a batch of I/O commands stored in a submission queue. In particular, each warp can be designated to process a certain workload type (e.g., random read commands, random write commands, sequential read commands, sequential write commands, parameter write commands, checkpoint write commands, prefill commands, key/value (KV) cache offload commands, etc.). When submitting I/O commands, the host system (e.g., application 150) can send certain type of I/O commands to and indicate workload type of the I/O commands. When the I/O commands are placed into a submission queue and/or a section of the submission queue for a particular warp, a corresponding context attribute that indicates the workload type of the I/O commands can be sent to the queue manager 128. Specifically, the workload type attribute can characterizes the set of warp-originated I/O commands currently the submission queue. This group characterization allows the memory sub-system to more efficiently allocate the memory in the memory device.

In some embodiments, the context attribute can be an operation code (opcode), metadata, etc. A random read command is an instruction to memory sub-system 110 to retrieve data from a non-contiguous, scattered set of memory addresses. This type of command typically involves accessing data blocks that are not physically adjacent on memory device 130. A random write command is an instruction to memory sub-system 110 to store data at non-contiguous, scattered memory addresses. Similar to the random read commands, random writes involve accessing disparate locations on memory device 130. A sequential read command is an instruction to memory sub-system 110 to retrieve data from a contiguous block of memory addresses. A sequential write command is an instruction to memory sub-system 110 to store data in a contiguous block of memory addresses. A parameter write command can modify or set specific parameters or configuration settings of a system, device, or application. A checkpoint write command can save the current state of a system, application, or process at a specific point in time. A prefill command is an instruction to proactively populate a cache with data that is anticipated to be needed in the future. This is done to reduce latency and improve performance when the data is actually requested by having it readily available in the faster cache memory. A KV cache offload command, when submitted from submission queue 124 to memory sub-system 110, is a specific instruction directing memory sub-system 110 to store a portion of the Key/Value (KV) cache associated with a Large Language Model (LLM) from host system’s 120 GPU memory into memory device 130. When queue management module 113 processes a particular warp (e.g., in response to detecting a write operation to a doorbell register), queue management module 113 can use the context attribute to determine the type of I/O commands in the submission queue or in a portion of the submission queue. Queue management module 113 can then process I/O commands for the warp according to their type. The memory sub-system can then process the I/O commands in a specific way based on the context attribute. For example, in instances where the context attributes indicates that the I/O commands are checkpoint writes, the memory sub-system can allocate a large section of memory for programming the corresponding data.

In some embodiments, queue management module 113 can use the workload types to infer a characteristic update frequency and/or an expected data lifetime of the data being accessed. Based on this inferred update frequency or expected data lifetime, queue management module 113 can manage the allocation of physical memory regions. For example, queue management module 113 can employ an allocation strategy where data associated with workload types exhibiting similar predicted update frequencies are preferentially allocated to physically proximate memory locations. This allocation can improve the utilization of the underlying memory data and a reduce the overhead of wear management processes.

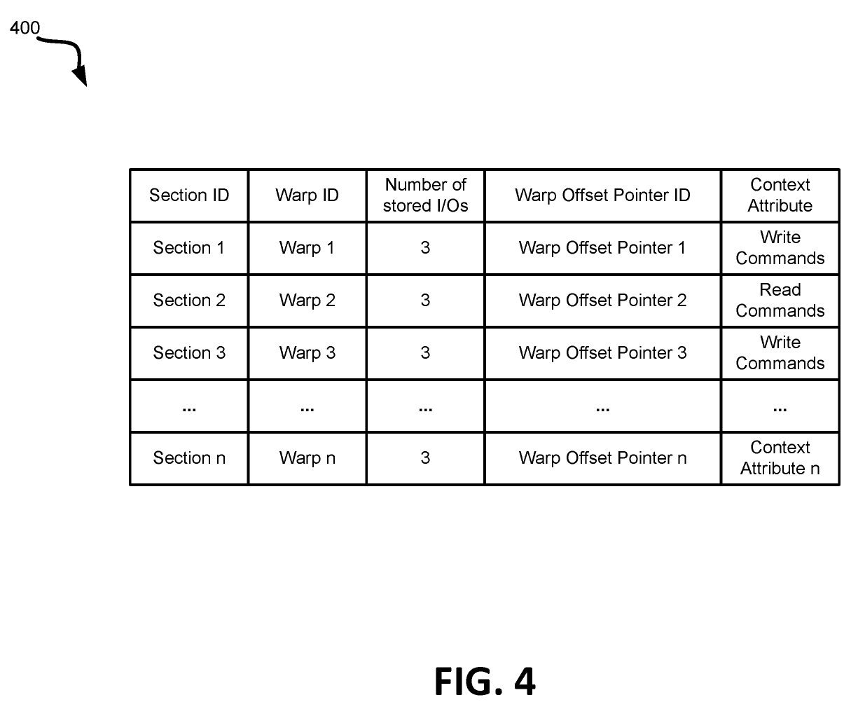

FIG. 4 schematically illustrates example queue metadata generated by a host system, in accordance with aspects of the present disclosure. In particular, queue metadata table 400 can be generated and periodically modified by a host system. Queue metadata table 400 can be stored in the host memory. The memory sub-system can access the table via PCIe direct memory access (DMA). The queue metadata table 400 can be assigned to a submission queue. In some embodiments, each submission queue can be assigned a corresponding queue metadata table. In other embodiments, two or more queue metadata tables can be assigned to a single submission queue and/or a single queue metadata table can be assigned to multiple submission queues.

As illustrated, queue metadata table 400 can include a column for listing the queue sections (i.e., queue section ID), a column for listing a corresponding warp identifier (e.g., a value that references to which warp the I/O commands in the section belong), a column for listing a corresponding number of I/O commands currently stored in the section, a warp offset pointer ID column to indicate, for example, the corresponding end location of each section, and a context attribute column to indicate the type of I/O commands stored in each section. In some embodiments, in response to a write operation performed to the submission queue’s doorbell register, the queue metadata table 400 can be provided to the memory sub-system. The memory sub-system can then use the data from the queue metadata table to aid in processing the I/O commands stored on the queue. For example, the memory sub-system can use the queue metadata table to determine the command types of each section, determine how many I/O commands are stored in each section, use the warp IDs to submit a completion status, for each I/O command, to the proper corresponding completion queue, etc.

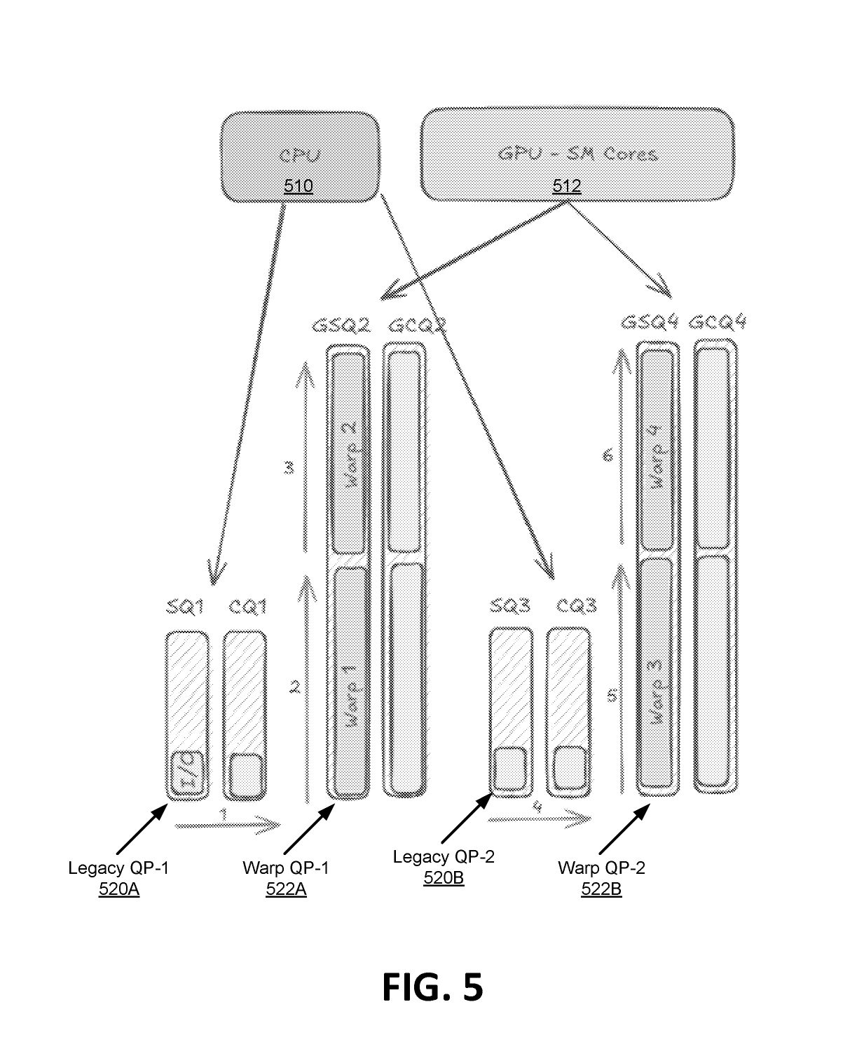

FIG. 5 is a block diagram illustrating an arbitration schedule between legacy queue pairs and warp queue pairs, in accordance with aspects of the present disclosure. A host system can include one or more CPUs 510 and one or more GPUs 512. The CPU 510 can instruct the memory sub-system to configure one or more legacy queue pairs 520A, 520B for its I/O commands to the memory sub-system. Each legacy queue pair can include a legacy submission queue (e.g., SQ1, SQ3) and a corresponding completion queue (e.g., CQ1, CQ3). Each of the legacy queues can include, for example, a circular memory buffer where I/O commands are processed one at a time.

The GPU 512 can instruct the memory sub-system to configure one or more warp queue pairs 522A, 522B for its I/O commands to the memory sub-system. Each warp queue pair can include a warp submission queue (e.g., GSQ2, GSQ4) and a corresponding completion queue (e.g., GCQ2, GCQ4). Each of the warp queues can include, for example, a linear memory buffer where I/O commands can be processed in batches according to the embodiment described herein. In this illustrative example, each warp submission queue (e.g., GSQ2, GSQ4) can correlate to a respective doorbell register configured to, in response to a write operation, executing a sequence of I/O commands from all of its section (e.g., sections warp 1 and warp 2 in GSQ2, and sections warp 3 and warp 4 in GSQ4).

The storage driver (e.g., storage driver 128), can perform a round robin arbitration scheme. As shown, one or more I/O commands from SQ1 are processed, then all of the I/O commands from GSQ2 are processed, then one or more I/O commands from SQ3 are processed, and finally all of the I/O commands from GSQ4 are processed. This arbitration scheme will loop back once completed. In other embodiments, other arbitration schemes can be used. For example, first all of the legacy submission queues are processed and then all of the warp submission queues are processed, or vice vera. This allows the memory sub-system to support a dual configuration where both the CPU and GPU can communicate with the memory sub-system without diminishing performance or incurring latency costs.

When processing an I/O command(s) from legacy submission queue, the memory sub-system receives no context regarding the workload type of the I/O command(s). As such, the memory sub-system expends computing resources to determine the workload type of the I/O commands. However, when processing I/O commands from a warp submission queue, the memory sub-system can obtain a context attribute for each batch of I/O commands (e.g., from a queue metadata table). The memory sub-system can then process the I/O commands in a specific way based on the context attribute.

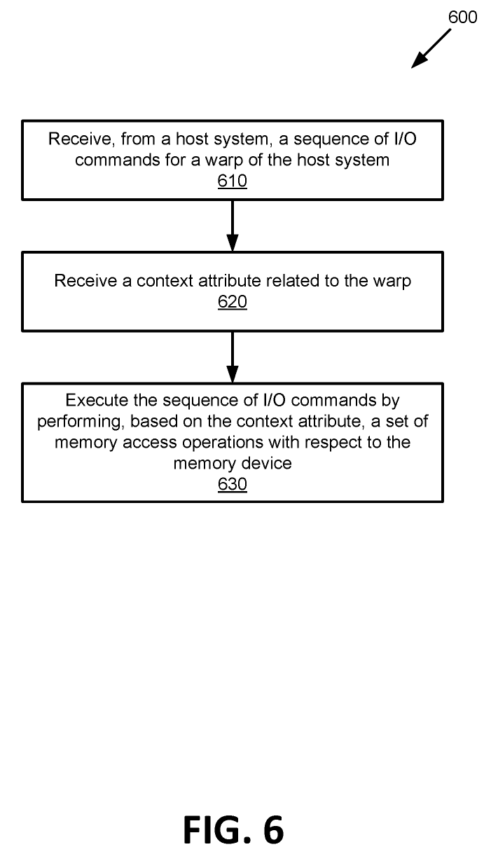

FIG. 6 is a flow diagram of an example method of processing warp specific I/O commands, in accordance with some embodiments of the present disclosure. Method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 300 is performed by the queue management module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic receives, from a host system, a sequence of I/O commands for a warp of the host system. The warp can include a set of processing threads of the host system that synchronously execute the same sequence of executable instructions.

At operation 620, the processing logic receives a context attribute related to the warp. The context attribute can specify a workload type corresponding to the sequence of I/O commands. For example, the workload type can indicate whether the sequence of I/O commands are read commands, write commands, prefill commands, key/value cache offload commands, etc. In some embodiments, the context attribute is stored in a metadata structure related to a warp command submission queue that stores the sequence of I/O commands. The metadata structure can further includes the number of I/O commands in the sequence of I/O commands.

At operation 630, the processing logic executes the sequence of I/O commands by performing, based on the context attribute, a set of memory access operations with respect to the memory device. In some embodiments, the warp submission queue can be related with a weight value referencing a processing order priority with respect to another warp command submission queue.

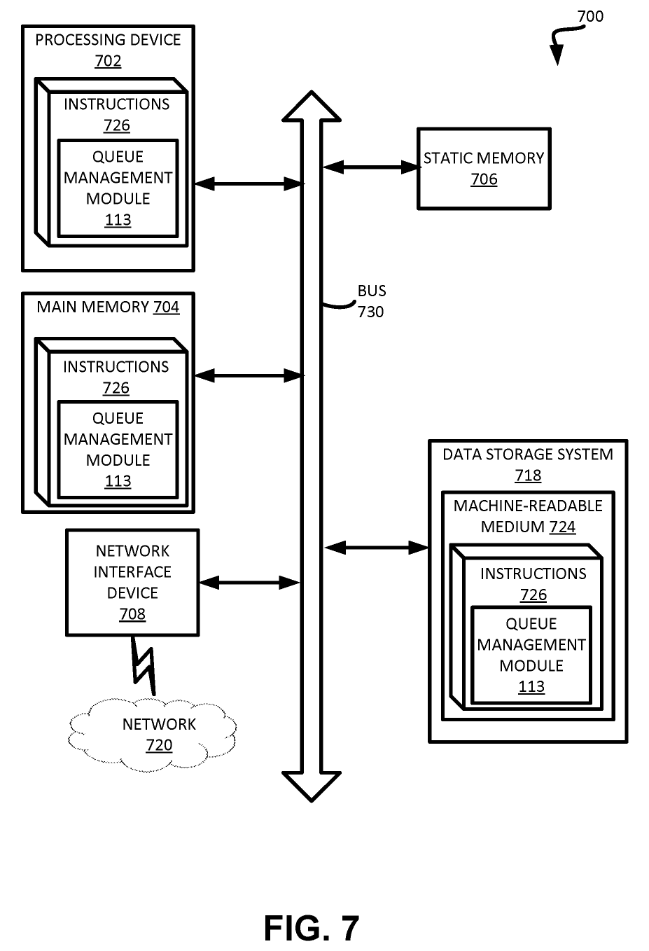

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the scan ahead module 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to the scan ahead module 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving, from a host system, a sequence of input/output (I/O) commands associated with a warp of the host system, wherein the warp comprises a set of processing threads of the host system that synchronously execute a same sequence of executable instructions;
receiving a context attribute associated with the warp;
executing the sequence of I/O commands by performing, based on the context attribute, a plurality of memory access operations with respect to the memory device.

2. The system of claim 1, wherein the context attribute specifies a workload type associated with sequence of I/O commands.

3. The system of claim 2, wherein the workload type indicates at least one of a read command or a write command.

4. The system of claim 1, wherein the workload type indicates at least one of prefill commands or key/value cache offload commands.

5. The system of claim 1, wherein the context attribute is stored in a metadata structure that is associated with an I/O command submission queue that stores the sequence of I/O commands.

6. The system of claim 5, wherein the metadata structure further includes the number of I/O commands in the sequence of I/O commands.

7. The system of claim 5, wherein the I/O command submission queue is associated with a weight value referencing a processing order priority over another I/O command submission.

8. A method, comprising:
receiving, from a host system, a sequence of input/output (I/O) commands associated with a warp of the host system, wherein the warp comprises a set of processing threads of the host system that synchronously execute a same sequence of executable instructions;
receiving a context attribute associated with the warp;
executing the sequence of I/O commands by performing, based on the context attribute, a plurality of memory access operations with respect to the memory device.

9. The method of claim 8, wherein the context attribute specifies a workload type associated with sequence of I/O commands.

10. The method of claim 9, wherein the workload type indicates at least one of a read command or a write command.

11. The method of claim 8, wherein the workload type indicates at least one of prefill commands or key/value cache offload commands.

12. The method of claim 8, wherein the context attribute is stored in a metadata structure that is associated with an I/O command submission queue that stores the sequence of I/O commands.

13. The method of claim 12, wherein the metadata structure further includes the number of I/O commands in the sequence of I/O commands.

14. The method of claim 12, wherein the I/O command submission queue is associated with a weight value referencing a processing order priority over another I/O command submission.

15. A non-transitory computer-readable storage medium comprising instructions that, when executed by a processing device, cause the processing device to perform operations comprising:
receiving, from a host system, a sequence of input/output (I/O) commands associated with a warp of the host system, wherein the warp comprises a set of processing threads of the host system that synchronously execute a same sequence of executable instructions;
receiving a context attribute associated with the warp;
executing the sequence of I/O commands by performing, based on the context attribute, a plurality of memory access operations with respect to the memory device.

16. The non-transitory computer-readable storage medium of claim 15, wherein the context attribute specifies a workload type associated with sequence of I/O commands.

17. The non-transitory computer-readable storage medium of claim 16, wherein the workload type indicates at least one of a read command, a write command, a prefill command, or a key/value cache offload command.

18. The non-transitory computer-readable storage medium of claim 15, wherein the context attribute is stored in a metadata structure that is associated with an I/O command submission queue that stores the sequence of I/O commands.

19. The non-transitory computer-readable storage medium of claim 18, wherein the metadata structure further includes the number of I/O commands in the sequence of I/O commands.

20. The non-transitory computer-readable storage medium of claim 18, wherein the I/O command submission queue is associated with a weight value referencing a processing order priority over another I/O command submission.
